(19) United States
(12) Patent Application Publication
(10) Pub. No.: US 2019/0191060 A1
(43) Pub. Date: Jun. 20, 2019

(54) SHOULDER MOUNTABLE PORTABLE COMMUNICATION DEVICE

(71) Applicant: MOTOROLA SOLUTIONS, INC, CHICAGO, IL (US)

(72) Inventors: JODY H. AKENS, WESTON, FL (US); RYAN M. NILSEN, PLANTATION, FL (US); CHI T. TRAN, WAUWATOSA, WI (US); JORGE L. GARCIA, PLANTATION, FL (US)

(21) Appl. No.: 15/841,392

(22) Filed: Dec. 14, 2017

(51) Int. Cl. H04N 5/225; H04N 5/232; H04R 1/02

(52) U.S. Cl. CPC H04N 5/2252; H04N 5/23238; H04R 2499/11; H04N 5/2253; H04R 1/028; H04N 5/2258

(57) ABSTRACT

A shoulder mountable communication device provides a remote speaker microphone (RSM), a camera, and a battery. The device is conformable to different user's to provide for a maximum imaging field of view and hands-free operation of the camera.

### FIELD OF THE INVENTION

The present invention relates generally to portable communication devices and more particularly to a portable shoulder mounted communication devices.

### BACKGROUND

Portable communication devices have been utilized by public safety personnel for years. While it is not unusual for several devices to be worn at various locations on the body at the same time, the ability to organize and efficiently handle several different body worn devices of different types and sizes may become tiresome, if not problematic for the user. In certain public safety environments, such as law enforcement, fire, and rescue, the ability to maintain a hands-free environment is the utmost importance. To this end, the integration of increased functionality into a single device can be desirable. However, the integration of several devices into one, presents challenges to engineering designers seeking to strike a balance between portability, user interface, size, and weight.

There is an increased desire for public safety personnel to provide video recordings interactions. While front facing body worn cameras have been used in the past, the results of such recordings are limited due to the recording area and much context of the area may not be recorded. There is a strong desire to capture increased information pertaining to a scene, whether for evidentiary purposes or for the overall safety of those at the scene.

Accordingly, an improved apparatus and manner of capturing video is desired that allows for hands-free manner.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a portable communication device formed and operating in accordance with some embodiments.

FIG. 2 shows optional attachment features for mounting the portable communication device to an article of clothing in accordance with some embodiments.

FIG. 3 is an alternative embodiment of the portable communication device in accordance with some embodiments.

FIG. 4 is another alternative embodiment of the portable communication device in accordance with some embodiments.

FIG. 5 is a block diagram of a portable communication device operating within a communications network in accordance with some embodiments.

FIG. 6 is a method of operating a portable communication device in accordance with some embodiments.

FIG. 7 shows the portable communication device mounted to a body worn article of clothing in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in a communication device having a remote speaker microphone and camera integrated therein. The camera is formed of one or more video 360 degree field of view hemispherical imagers. The communication device is formed of a portable housing providing a shoulder conformable flexible housing, a remote speaker microphone (RSM) integrated into the portable housing, at least one video imager integrated into the housing, the at least one video imager providing at least a 360 degree field of view, and at least one battery integrated into the housing for powering the RSM and the at least one imager.

In one embodiment, the imager comprises first and second hemispherical convex video imagers coupled to a mounting frame located on the top portion of the portable housing, which operating together provide a full spherical field of view. In an alternative embodiment, the imager comprises a first video imager located on the front portion of the housing, and a second video imager located on a back surface of the portable housing, the first and second video imagers are each hemispherical imagers, which operating together provide a full spherical field of view. In yet another alternative embodiment, the imager comprises a single hemispherical video imager coupled to a mounting frame located on the top portion of the portable housing, the single hemispherical video imager providing a 360 degree field of view. The portable communication device, formed in accordance with the embodiments, provides for hands-free and eyes-up enhanced image capturing with ease of access to the remote speaker microphone user interface and is thus well suited as a portable public safety communication device for public safety environments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

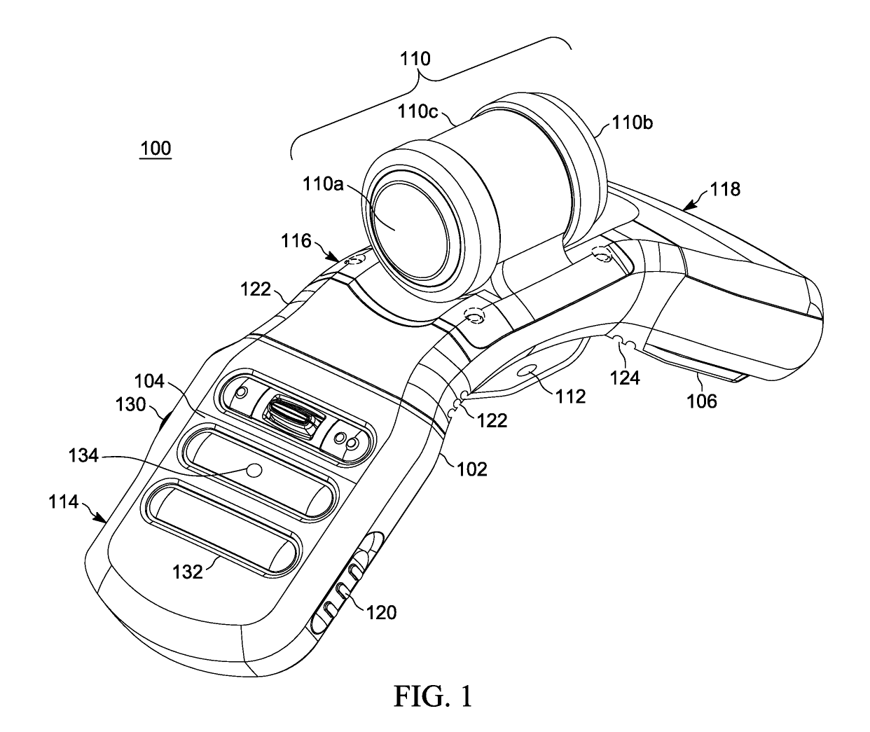

FIG. 1 is a communication device 100 formed in in accordance with some embodiments. The communication device 100 is a portable, body wearable device for shoulder worn usage particularly well suited to public safety environments, such as law enforcement and fire rescue. The portable housing 102 is formed of a shoulder conformable flexible housing preferably formed of front, top and back portions 114, 116, 118 respectively configured in a reverse u-shape formation. The remote speaker microphone (RSM) 104 is integrated into the front housing portion 114, the battery is integrated into the back housing portion 118, and in accordance with this embodiment at least one video imager providing a 360 degree field of view is coupled to the top portion 116 of the portable housing 102. In this embodiment, the at least one imager is coupled by a camera mounting frame 108 protruding from the top housing portion 116 retaining first and second convex lenses 110a, 110b are hemispherical lenses each providing a 360 degree field of view in opposing directions, which combined form provide a full spherical field of view. In accordance with this embodiment, the first and second convex video imagers 110a, 110b are coupled to the camera mounting frame 108 in a back-to-back configuration to provide the full spherical field of view. The RSM 104 integrated within the front housing portion 114 comprises a speaker 132, a microphone 134, and a push-to-talk (PTT) button 130, all under the control of one or more internal processors and interoperable with an internal transceiver. The battery 106 powers the RSM 104 and the at least one imager.

The device 100 is advantageously worn at the shoulder. Mounting portable communication device 100 to the shoulder may be accomplished under a variety of attachment features 112 including but not limited to clips, snaps, magnets, slide-in features, shoulder harness or holster and/or epaulette interface. The shoulder conformable flexible housing may be formed of ruggedized plastic with flexible sections 126, 128 jointed between the RSM and video imager, as well as jointed between the video imager and battery. In accordance with some embodiments, the strain reliefs 122, 124 may further comprise flex interconnects running therethrough to electrically and mechanically couple the RSM 104 electronics to the camera and the battery. Locating the battery on the back portion of the housing advantageously provides balance with the front mounted RSM.

Flexible sections 122 and 124 provide flexibility between rigid housing sections (RSM, camera, and battery). These sections allow the overall device to contour to various shoulder sizes. The flexible sections 122, 124 may be made of rubber-like materials. The flexible sections 122, 124 further provide an interior interconnect path within which a flexible circuit or wires may be passed for electrically interconnecting the rigid housing sections (RSM, camera, and battery).

Once properly mounted to the user's shoulder, the user is able to perform duties in a hands free environment. The ability to capture video while maintaining a hands-free environment allows the user to continue operating the RSM. The processing capabilities of the RSM may further be used to control the electronics of the camera thus advantageously providing for a portable RSM controlled camera providing 360 degree field of view.

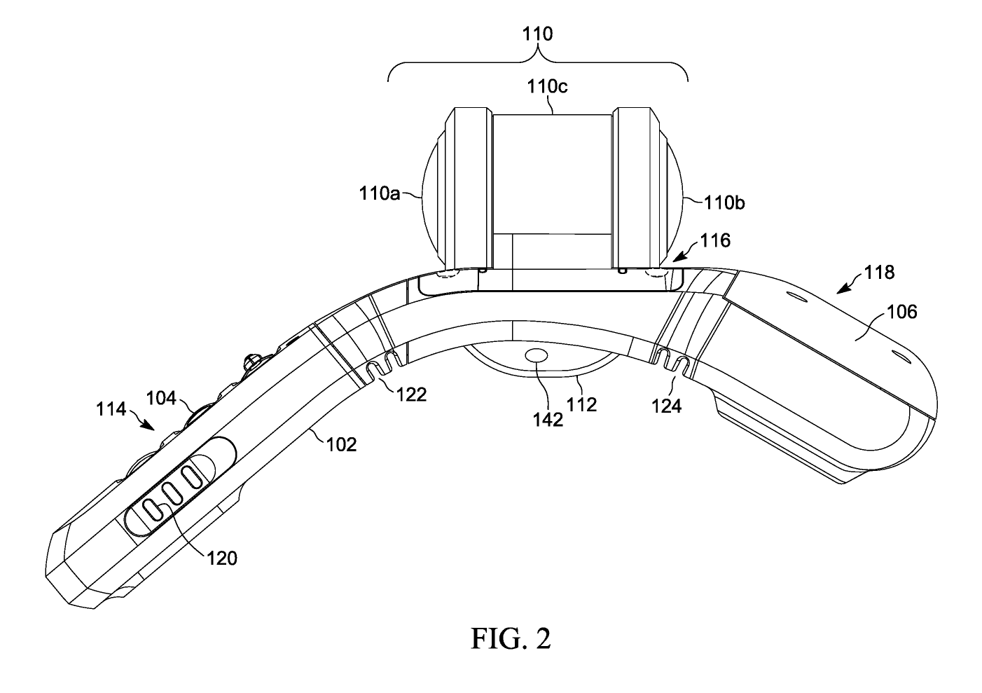

The ability of the portable communication device 100 to flexibly conform to a user's shoulder advantageously provides for a comfortable form fit that can be easily secured to clothing with a variety of attachment articles. FIG. 2 shows optional attachment articles for mounting the portable communication device 100 to an article of clothing, such as a vest or shirt, in accordance with some embodiments. The attachment features 112 may comprise one or more of clips, snaps, hook and loop, magnets and straps to name a few. The attachment features 112 may be located on one or more portions (front, back, top) of the portable communication device to ensure that the device remains optimally situated for that individual and for optimal image capturing by the camera. Variable adjustment positions of the attachment features 112 can be used to ensure a customized fit for each user. Thus, the portable communication device 100 can advantageously provide a flexible conformity to a variety of different shoulder form factors. The attachment feature enables positioning of the camera of the portable communication device for individual user configurations and proportions.

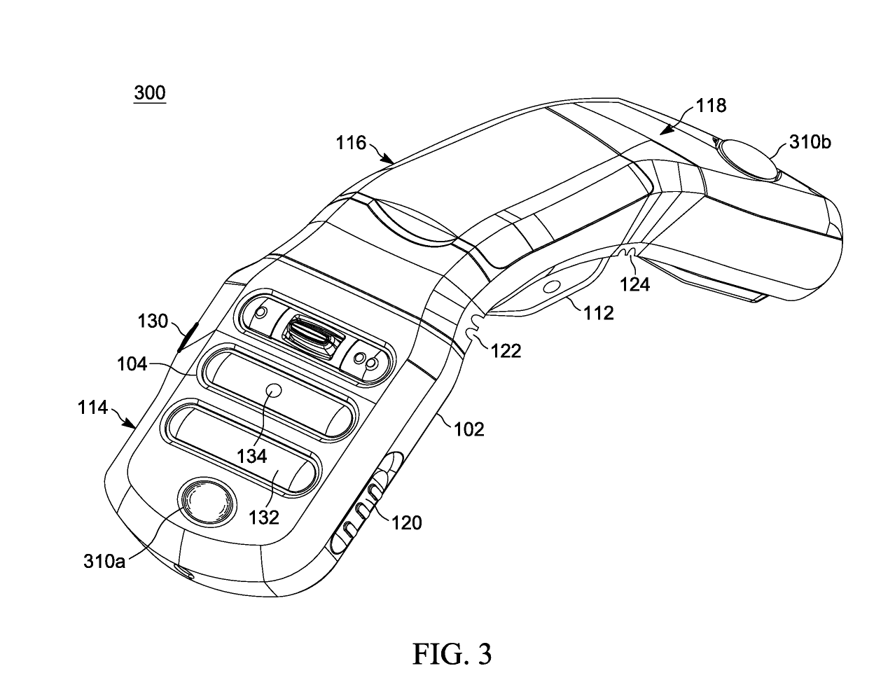

While the embodiment of FIGS. 1 and 2 provides for dual imagers coupled to the top portion of the housing, another dual imager embodiment provides for individual hemispherical imagers to be located on the front and back portions of the portable communication device. FIG. 3 is a communication device 300 formed in accordance with some embodiments. The portable communication device of FIG. 3 retains the portable housing 102 formed of the shoulder conformable flexible housing. Again, the flexible housing is formed as a reverse u-shaped flexible housing having front, top and back portions 114, 116, 118.In this embodiment, rather than the protruding as the top mounted camera, the at least one imager is formed of a first imager 310a located on the front portion 114 of the housing 102 and a second imager 310b located on a back portion 118 of the portable housing. Each of the first and second imagers, formed of hemispherical lenses, provide a 360 degree field of view independently in rearward and forward facing directions. In this embodiment, the battery 106 again powers the RSM 104 and electronics associated with imagers 310a, 310b.

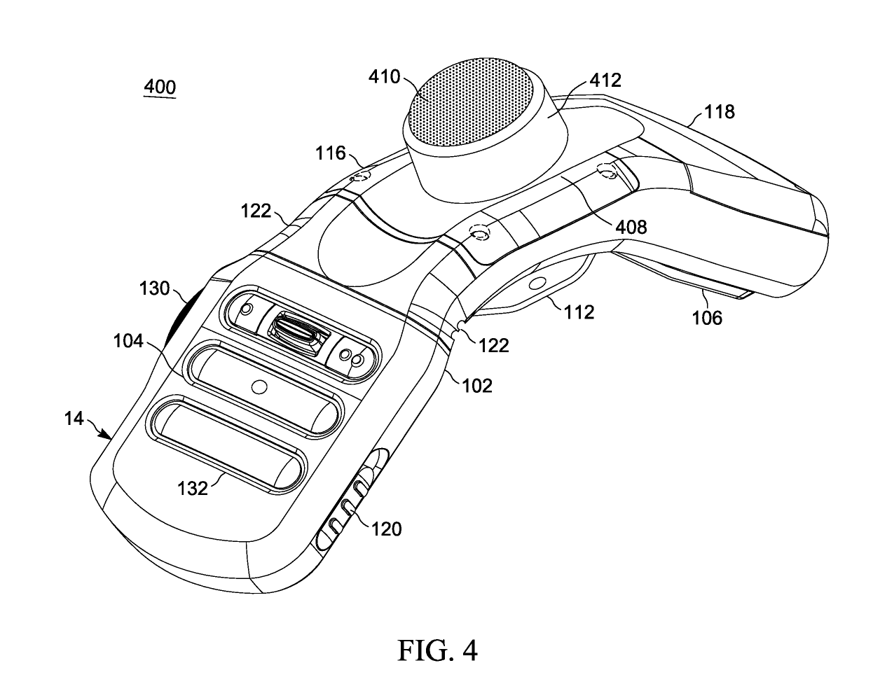

The embodiments of FIGS. 1, 2, and 3 provide first and second imagers in a dual imager formation of first and second convex lenses. FIG. 4 shows yet another embodiment, in which a single hemispherical lens is mounted to the top portion 116 of the flexible shoulder a single spherical video imager 410 is coupled to a mounting frame 408 located on the top portion 116 of the portable housing 102, the single hemispherical video imager providing a 360 degree field of view.

Accordingly, the various embodiments provide for a communication device 100, 300, 400 formed as a portable, body wearable device for shoulder worn applications particularly well suited to public safety environments, such as law enforcement and fire rescue. The portable housing of the various embodiments being formed of a shoulder conformable flexible housing having integrated therein: the remote speaker microphone (RSM) 104, the at least one video imager providing the at least a 360 degree field of view, and the at least one battery for powering the RSM and the at least one imager, together provide for an improved public safety portable communication device. The at least one video imager has been advantageously provided by the various embodiments via the dual convex imaginers 110a, 110b as described in FIGS. 1 and 2 which provide a for a full spherical field of view, the dual convex imaginers 310a, 310b as described in FIG. 3 which also provide for a full spherical field of view, and the single convex imager 410 as described in FIG. 4 which provides a single hemispherical for the 360 degree field of view.

In some embodiments, a controller of the portable communication device 100, 300 or 400 may provide an automated feedback signal, such as an audio tone or series or tones to notify the user that proper positioning of the camera has been achieved for a maximized field of view. In order to generate such feedback signals, the camera 110a, 110b, or 310a, 310b, or 410 may be turned on temporarily in response to a button press 120 and/or trigger signal in response to the attachment features being secured. By temporarily enabling the camera to measure samples of the field of view, and generating tones in response thereto, the user is thus able to make positioning adjustments, based on the tones, to ensure a maximum field of view has been achieved.

The operation of the portable communication device can thus commence including such functions as playing out audio at the remote speaker 132 of the RSM or pressing a push-to-talk (PTT) button 130 to transmit from the RSM. Camera operation of the portable communication device is enabled either manually through a dedicated button or automatically in response to some predetermined input to the portable communication device, such as a press to the PTT button 130 with verbal command “start video” to RSM microphone 134. Hands-free recording of video is thus available to the user with a maximum field of view.

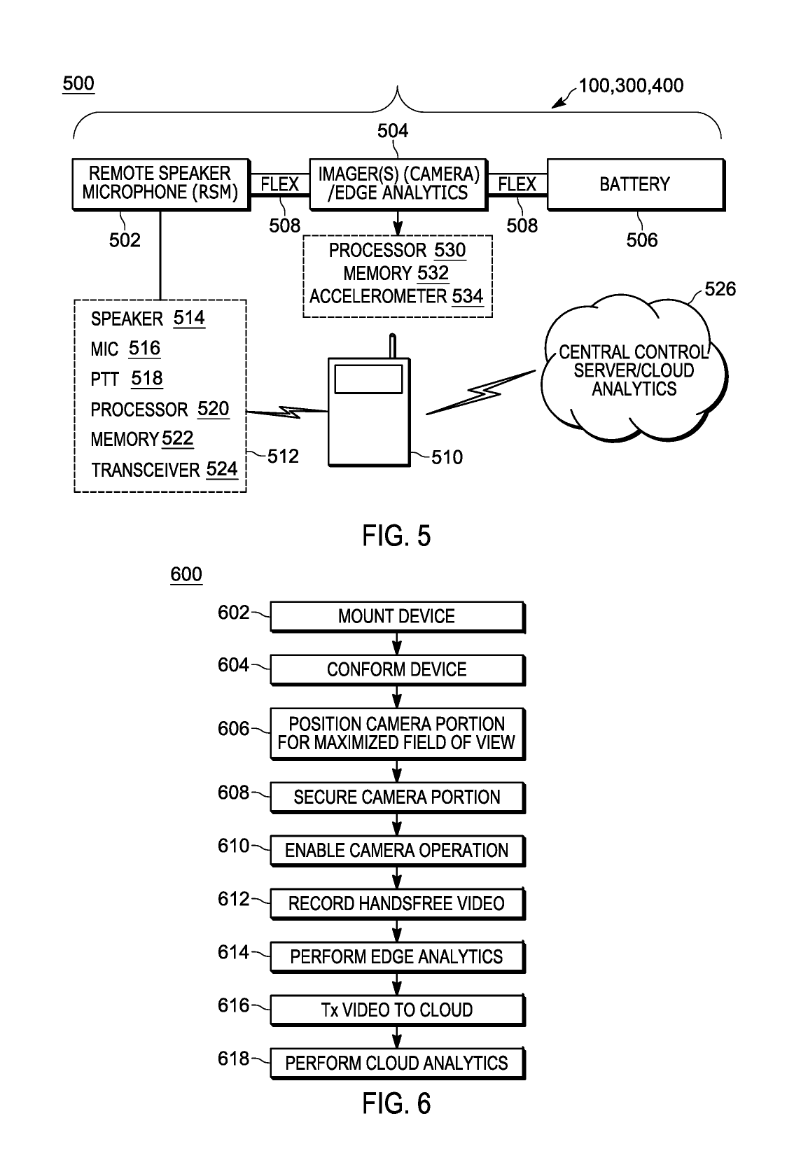

FIG. 5 is a block diagram of a portable communication device 100, 300 or 400 operating within a communications network 500 in accordance with some embodiments. The portable communication device 100, 300, or 400 comprises electronics associated with a remote speaker microphone (RSM) 502, a camera 504, and a battery 506. In accordance with the various embodiments the camera 504 provides at least a 360 degree field of view via a single hemispherical imager. The camera 504 may alternatively be formed of dual convex video imagers to provide a full spherical field of view. The RSM 502, camera 504, and battery 506 may be mechanically and electrically interconnected via a flex 508 having circuit traces integrated therein. Flex circuitry 508 lends itself well to being folded, for example in an accordion or pleated formation, or rolled, for example in a ribbon formation, thereby providing adjustable flexibility between the three portions of the device. The accordion or ribbon formations of the flex 508 are well suited for location within the flexible sections 122, 124 (shown in previous figures), thereby advantageously permitting a user to adjust positioning of the device upon the shoulder via flexible sections of the device 100, 300, 400.

While the block diagram of a FIG. 5 shows first and second flex interconnects 508, it is appreciated that in some embodiments, such as the embodiment of FIG. 4, a single flexible section 122 with flex interconnect contained therein can be used.

Operationally, the RSM 502 may comprise electronics 512 such as a speaker 514, a microphone 516, a PTT witch 518, one or more processors 520, memory storage 522, and a transceiver 524. The RSM 502 transmits and receives wireless signals to and from a portable radio 510. The portable radio 510 may comprise a two-way portable radio worn at the belt, coupled via a radio frequency (RF) communications link to the RSM 502. The portable radio 510 may be in further communications with a central control server 526, as part of a public safety communications network.

In accordance with some embodiments, the portable shoulder mounted communication device 100, 300, or 400 operating within the network 500 can be used in license plate recognition, face detection, and other edge analytics. The network's central controller 526 can perform video analytics on the video recorded by the shoulder mounted communication device 100, 300, or 400, for example face identification to a server registry. Depending on the memory capacity of the portable shoulder mounted communication device 100, 300, or 400 some edge analtyics may be performed locally using the device's memory and processor.

The central control server 526 may operate as part of a base station, a dispatch center or other network control device, providing appropriate protocol processing for database interconnectivity, management and storage of data, voice, and video captured by the RSM controlled camera 504. Video captured by the camera 504 may be temporarily stored in memory 522 and wirelessly transmitted by the RSM 502 to the portable radio 510, where further storage may take place, and then wirelessly transmitted from the portable radio 510 to the central control server 526. Thus, 360 degree video captured by the camera 504 can be forwarded from the RSM, to the radio, and then to the central control server 526.

The one or more processors 520 control operation of the RSM transceiver 524 and audio associated with the speaker 514 and microphone 516. The one or more processors 520 further control electronics associated with the camera 504 and battery circuitry of battery 506. The PTT 518, as described previously, can be used to enable automated video recording by a PTT press with appropriate voice command into microphone 516. Alternatively a dedicated button can be used to enable the video recording. One or more of the processors 520 provide video processing for the camera 504 while memory 522 provides temporary storage of video captured by the device 100, 300, or 400.

The various embodiments, either 360 field of view or full spherical image capture, advantageously avoid difficult alignment positioning requirements, such as needed in devices having a narrower field of view. Positioning the camera near the top of the user's shoulder minimizes blocking. A level check may be provided, if desired, by a built-in six-axis accelerometer. Leveling feedback to the user may be provided through an audible tone from the RSM speaker.

Accordingly, there has been provided a portable shoulder mounted communication device 100, 300, 400 that provides RSM control over a shoulder mounted camera for 360 degree field of view or full spherical image capture within a communications network 500.

FIG. 6 is a method 600 of operating a portable communication device in accordance with some embodiments. The method is provided for the top mounting of the camera as was shown in FIG. 1 but applies to the other configurations as well. The method begins at 602 by mounting the portable communication device to a shoulder of a user worn article of clothing, the portable communication device comprising a remote speaker microphone (RSM), a camera and a battery. At 604, the user conforms the portable communication device to the shoulder, via at least one flexible strain relief, such that the remote speaker microphone is situated on the front of the shoulder, the camera at the top of the shoulder, and the battery on the back of the shoulder. As previously described, the strain relief having internal flex can be adjusted, bent, and flexed to conform the device to the shoulder. The portable communication device can then positioned at 606 such that the camera obtains a maximized field of view. The maximized field of view may be verified by, for example, a level check performed by a built-in accelerometer along with feedback to the user.

The camera is then secured at 608 to the user worn article of clothing via an attachment feature at the position determined to obtain the maximized field of view. Camera operation is then enabled at 610 which allows recording of hands free and eyes up video at 612. The hands free video recording may be enabled by the push-to-talk (PTT) button along with a verbal command. Alternatively, the hands free video recording may be enabled by a dedicated button press. The hands free video recording may, in some embodiments, be enabled by a predetermined audio command to an always-on microphone. The recorded handsfree video can be stored and edge analytics performed on the stored video at 614.

Method 600 advantageously allows playing out audio at a remote speaker of the RSM during the recording of video, and pressing a push-to-talk (PTT) button to transmit from the RSM. By recording hands free and eyes up video, the RSM remains available to transmit a communication and receive a communication during the video recording. Edge analytics of a video recording can be performed in parallel with normal RSM usage.

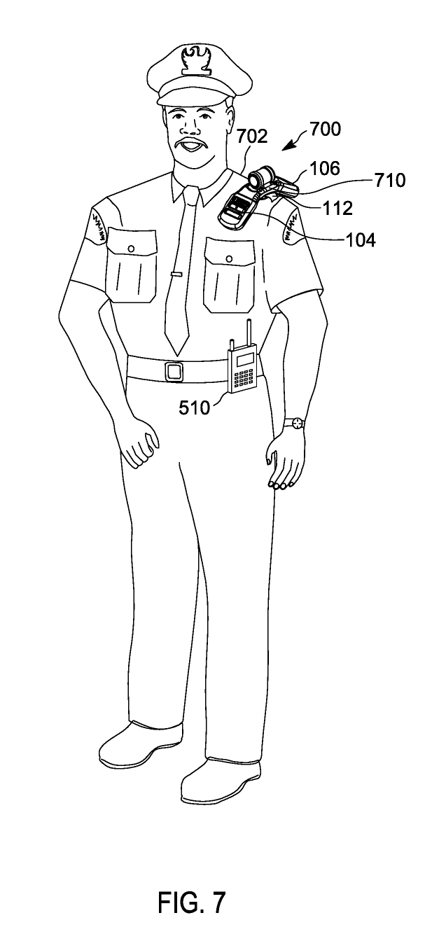

FIG. 7 shows a portable communication device 700 formed in accordance with the various embodiments mounted to a body worn article of clothing 702 in accordance with some embodiments. The body worn article of clothing 702 may comprise a shirt, vest, harness or other clothing article worn at the shoulder. The attachment features 112, as previously described, may be located on one or more housing portions (front, back, top) of the portable communication device to ensure that the device remains optimally situated for that individual and for optimal image capturing by the camera. The RSM 104, at least one 360 video imager 710 (which can be formed of imagers from the various embodiments 110a/110b, 310a/310b, or 410), and battery 106 are electronically and mechanically coupled via the previously described flexible electronic interconnects located within the at least one strain relief 122 and/or 124 of the portable communication device. Variable adjustment positions of the attachment features 112 can be used to ensure a customized fit for each user while providing for maximized video capture. Thus, the portable communication device 700 can advantageously provide a flexible conformity to a variety of different shoulder form factors. The attachment feature(s) 112 enable positioning of the camera for optimum video capture while the flexibility of the device provided by the strain relief section(s) 122 and/or 124 provide adjustability for individual user configurations and proportions. As previously described, the RSM transmits and receives wireless signals to and from the portable radio. The portable radio 510 may comprise a two-way portable radio worn at the belt, coupled via a radio frequency (RF) communications link to the RSM. Imaging data (360 or full spherical field of view) is captured by the camera and transferred via a wireless link shoulder mounted communication device to the portable radio for further transmission to a remote server, as previously described.

Accordingly, there has been provided a portable communication device which provides maximum field of view imaging in conjunction with RSM capability. Video can now be advantageously recorded without requiring that a user manually hold the video device and maintain an eyes-up position while recording. The video recorded by the portable communication devices of the various embodiments may further capture the users neck and side of face which can be advantageous as part of the overall analytics as well as for evidentiary purposes. The ability to capture the direction of the officer's face and facial expression is not possible with current bodyworn camera systems.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A communication device, comprising:
a portable housing, the portable housing being formed of a shoulder conformable flexible housing;
a remote speaker microphone (RSM) integrated into the portable housing;
at least one video imager integrated into the housing, the at least one video imager providing at least a 360 degree field of view; and
at least one battery integrated into the housing for powering the RSM and the at least one video imager.

2. The communication device of claim 1, wherein the shoulder conformable flexible housing is formed as a reverse u-shaped flexible housing having front, top and back housing portions.

3. The communication device of claim 2, wherein the at least one video imager comprises:
first and second hemispherical imagers coupled to a mounting frame located on the top housing portion, the first and second hemispherical imagers providing full spherical image capturing

4. The communication device of claim 2, wherein the at least one video imager comprises:
a first hemispherical video imager located on the front housing portion; and
a second hemispherical video imager located on the back housing portion, the first and second hemispherical video imagers providing a full spherical field of view.

5. The communication device of claim 2, wherein the at least one video imager comprises:
a single hemispherical video imager coupled to a mounting frame located on the top housing portion of the portable housing, the single hemispherical video imager providing a 360 degree field of view.

6. A communication device, comprising:
a portable housing, the portable housing being formed of a shoulder conformable flexible housing having front, top and back portions configured in a reverse u-shape formation;
a remote speaker microphone (RSM) integrated into the front housing portion;
a battery integrated into the back housing portion; and
a camera mounting frame protruding from the top housing portion of the portable housing; and
first and second hemispherical video imagers retained within the camera mounting frame, and wherein the battery powers the RSM and the first and second hemispherical video imagers.

7. The communication device of claim 6, wherein the first and second hemispherical imagers are coupled to the camera mounting frame in a back-to-back configuration to provide a full spherical field of view.

8. The communication device of claim 6, wherein the communication device comprises a portable public safety communication device.

9. The communication device of claim 6, further comprising:
an attachment feature for mounting to a clothing article.

10. The communication device of claim 9, wherein the attachment feature comprises one or more of: clips, snaps, magnets, hook and loop, and straps.

11. The communication device of claim 9, wherein the attachment feature enables positioning of the communication device for individual user configuration and proportion.

12. The communication device of claim 6, wherein the RSM, camera, and battery are electronically and mechanically coupled via flexible electronic circuits within a strain relief of the communication device.

13. The communication device of claim 6, wherein the communication device is a portable public safety communication device.

14. A method of operating a portable communication device, comprising:
mounting the portable communication device to a shoulder of a user worn article of clothing, the portable communication device comprising a remote speaker microphone (RSM), a video imager, and a battery;
conforming the portable communication device to the shoulder, via at least one flexible strain relief, such that the RSM is situated on a front of the shoulder, the camera at a top of the shoulder, and the battery on a back of the shoulder;
positioning the camera portion of the portable communication device to obtain a maximized field of view;
securing the camera to the user worn article of clothing via an attachment feature at the position determined to obtain the maximized field of view;
enabling camera operation of the portable communication device; and
recording hands-free video at the camera of the portable communication device.

15. The method of operating the portable communication device of claim 14, further comprising:
playing out audio at a remote speaker of the RSM.

16. The method of operating the portable communication device of claim 14, further comprising:
pressing a push-to-talk (PTT) button to transmit from the RSM.

17. The method of operating the portable communication device of claim 14, wherein the hands-free video recording is enabled by a push-to-talk (PTT) press along with a predetermined verbal command.

18. The method of operating the portable communication device of claim 14, wherein the hands-free video recording is enabled by a dedicated button press.

19. The method of operating the portable communication device of claim 14, wherein the video imager comprises a single hemispherical video imager providing a 360 degree field of view.

20. The method of operating the portable communication device of claim 14, wherein the video imager comprises dual hemispherical imagers providing a full spherical field of view.

21. The method of operating the portable communication device of claim 14, further comprising:
storing the recorded handsfree video; and
performing edge analytics on the stored video.

22. The communication device of claim 1, further comprising:
a built-in six-axis accelerometer to provide a level check of alignment; and
a speaker of the RSM generating an audible tone indicative of the level check of the alignment.

23. The communication device of claim 6, further comprising:
a built-in six-axis accelerometer to provide a level check; and
a speaker of the RSM generating an audible tone indicative of the level check of the alignment.

24. The method of operating the portable communication device of claim 14, further comprising:
generating an audible tone from the RSM speaker indicative of a level check of the alignment.

25. The communication device of claim 1, wherein the portable communication device is mounted to a body worn article of clothing worn at the shoulder.

26. The communication device of claim 25 wherein the body worn article of clothing worn at the shoulder comprises one of: a shirt, a vest, a harness.

27. The communication device of claim 6, wherein the portable communication device is mounted to a body worn article of clothing worn at the shoulder.

28. The communication device, of claim 27, wherein the body worn article of clothing worn at the shoulder comprises one of: a shirt, a vest, and a harness.

29. The method of operating the portable communication device of claim 14, further comprising:
mounting the portable communication device to a body worn article of clothing worn at the shoulder.

30. The method of operating the portable communication device of claim 28, wherein the body worn article of clothing comprises one of: a shirt, a vest, and a harness.
